(19) United States
(12) Patent Application Publication
(10) Pub. No.: US 2010/0125908 A1
(43) Pub. Date: May 20, 2010

(54) STORAGE DEVICE, INFORMATION PROCESSOR, AND INFORMATION PROCESSING SYSTEM

(75) Inventor: Yoshiyuki Kudo, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,501

(22) Filed: Sep. 29, 2009

(30) Foreign Application Priority Data
Nov. 18, 2008 (JP) 2008-294008

(51) Int. Cl. G06F 7/04; G06F 12/14

(52) U.S. Cl. 726/19

(57) ABSTRACT

According to one embodiment, a storage device includes a storing module, a determining module, and a releasing module. The storing module stores generated authentication information generated by a host connected to the storage device and set as authentication information for releasing access restriction to a storage module in the storage module. The determining module determines, when the storage device is turned on upon the host resuming from suspend mode and receives generated authentication information from the host in a state where access to the storage module is restricted, whether the generated authentication information matches the generated authentication information stored by the storing module in the storage module. The releasing module releases, when the determining module determines that the generated authentication information received from the host matches the generated authentication information stored by the storing module in the storage module, the access restriction to the storage module.

### CROSS-REFERENCE TO RELATED APPLICATIONS

This application is based upon and claims the benefit of priority from Japanese Patent Application No. 2008-294008, filed Nov. 18, 2008, the entire contents of which are incorporated herein by reference.

### BACKGROUND

1. Field

One embodiment of the invention relates to access authentication for a storage device.

2. Description of the Related Art

When a password is set to a storage device having a password for controlling access, if unlocked with the password, the storage device maintains the unlocked state until the power is turned off and is locked with the password when the power is turned off. If the password is set to the storage device, in a conventional system environment including such a storage device and a host, password authentication is performed when the system is started. The system region is read out after the storage device is unlocked with the password.

For example, in a hard disk, two passwords, i.e., a master password and a user password, can be set according to the standard of the advanced technology attachment (ATA). The access to the hard disk can be restricted by setting the two passwords by a user or a system.

A computer system including the storage device as described above will be described with reference to FIG. 6. FIG. 6 is a block diagram of a computer system that performs password authentication at start-up. The computer system as illustrated in FIG. 6 includes a host personal computer (PC) 1 and an information storage device 2. The host PC 1 includes a central processing unit (CPU) 11, a controller 12, a user interface 13, and a device interface 14. The information storage device 2 includes a microprocessing unit (MPU) 21, a read/write controller 22, a storage module 23, a controller 24, a host interface 25, and a random access memory (RAM) 26.

In such a computer system, a user inputs a password to the host PC 1 through the user interface 13 when the system is started to release restriction to access to the storage module 23 so that the host PC 1 can read starting data. If the host PC 1 enters suspend mode, for example, and the power is interrupted, the information storage device 2 automatically transits to the locked state with the password (password lock state). That is, in such a case, the information storage device 2 is in the same state as the normal power-off due to the interruption of the power supply. In the suspend mode, however, the power of the host PC 1 is not completely shut down. Consequently, to resume from the suspend mode, the host PC 1 accesses the information storage device 2 in the same manner as before the transition to the suspend mode without requiring password input by the user, unlike when the power is turned on or resuming from a hibernation state. At this time, the host PC 1 needs the password to readout information necessary for resuming because the information storage device 2 has returned to the password lock state. Accordingly, the host PC 1 uses the password input by the user and stored in a management region of the system in the storage module 23 or a memory 15 that are accessible even in the password lock state to unlock the information storage device 2 again when the system is recovered.

As such a conventional technology, a hibernation recovery method is known. In this method, restoration information necessary to restore the state is stored in a removable external storage device at the hibernation processing, hibernation passwords including the time, checksum, etc. of the restoration information are stored in a battery backup memory and the external storage device, respectively, and the hibernation passwords are compared at the time of recovery. Only when the hibernation passwords match, wakeup is performed according to the restoration information stored in the external storage device (see, for example, Japanese Patent Application Publication (KOKAI) No. 10-149236).

If, as described above, a password input by the user is retained to unlock an information storage device with the password when a host PC resumes from suspend mode and used at a timing that the user does not intend, security concerns arise.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a hardware configuration of a computer system according to an embodiment of the invention;

FIG. 2 is an exemplary functional block diagram of a host PC in the embodiment;

FIG. 3 is an exemplary functional block diagram of an information storage device in the embodiment;

FIG. 4 is an exemplary flowchart of a password setting process for resuming from suspend in the embodiment;

FIG. 5 is an exemplary flowchart of a password authentication process for resuming from suspend in the embodiment; and

FIG. 6 is an exemplary block diagram of a computer system that performs password authentication at start-up according to a conventional technology.

### DETAILED DESCRIPTION

Various embodiments according to the invention will be described hereinafter with reference to the accompanying drawings. In general, according to one embodiment of the invention, a storage device comprises a storing module, a determining module, and a releasing module. The storing module is configured to store generated authentication information generated by a host connected to the storage device and set as authentication information for releasing access restriction to a storage module in the storage module. The determining module is configured to determine, when the storage device is turned on upon the host resuming from suspend mode and receives generated authentication information from the host in a state where access to the storage module is restricted, whether the generated authentication information matches the generated authentication information stored by the storing module in the storage module. The releasing module is configured to release, when the determining module determines that the generated authentication information received from the host matches the generated authentication information stored by the storing module in the storage module, access restriction to the storage module.

According to another embodiment of the invention, an information processor comprises a generating module, a setting module, and a transferring module. The generating module is configured to generate predetermined authentication information as generated authentication information. The setting module is configured to set the generated authentication information generated by the generating module to a storage device connected to the information processor as authentication information for releasing access restriction to a storage module of the storage device. The transferring module is configured to transfer, when the storage device is turned on upon the information processor resuming from suspend mode and access to the storage module is restricted, the generated authentication information generated by the generating module to the storage device.

According to still another embodiment of the invention, an information processing system comprises an information processor and a storage device configured to be connected to the information processor. The information processor comprises a generating module, a setting module, and a transferring module. The generating module is configured to generate predetermined authentication information as generated authentication information. The setting module is configured to set the generated authentication information generated by the generating module to the storage device as authentication information for releasing access restriction to a storage module of the storage device. The transferring module is configured to transfer, when the storage device is turned on upon the information processor resuming from suspend mode and access to the storage module is restricted, the generated authentication information generated by the generating module to the storage device. The storage device comprises a storing module, a determining module, and a releasing module. The storing module is configured to store the generated authentication information set by the setting module in the storage module. The determining module is configured to determine, upon receipt of the generated authentication information from the transferring module of the information processor, whether the generated authentication information matches the generated authentication information stored by the storing module in the storage module. The releasing module is configured to release the access restriction to the storage module when the determining module determines that the generated authentication information received from the transferring module of the information processor matches the generated authentication information stored by the storing module in the storage module.

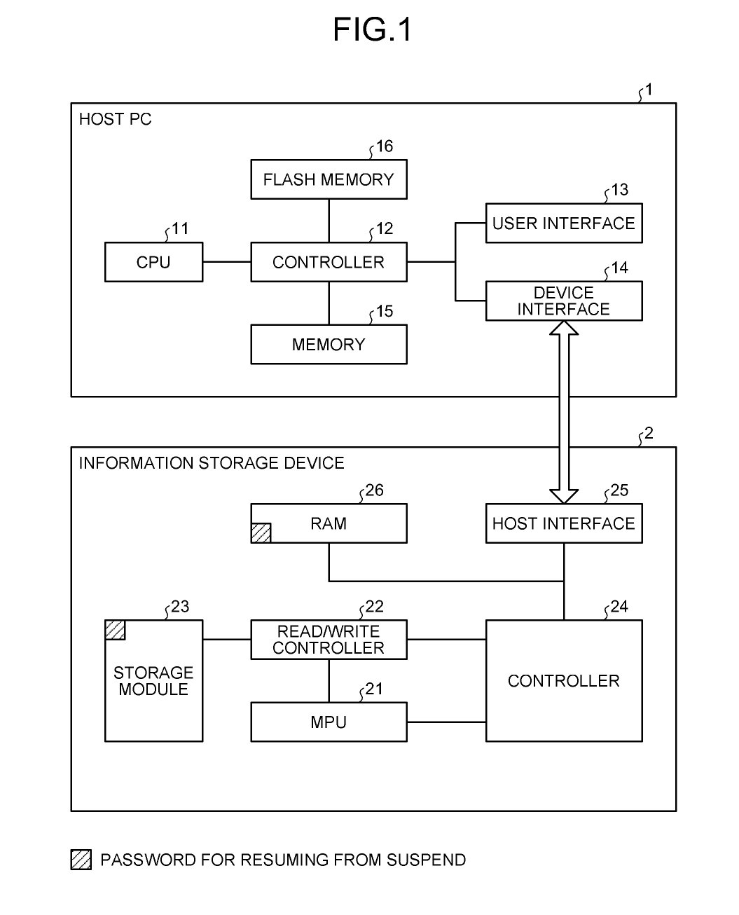

FIG. 1 is a block diagram of a hardware configuration of a computer system according to an embodiment of the invention. The computer system (information processing system) of the embodiment comprises the host PC 1 (an information processor) and the information storage device 2 (a storage device). The host PC 1 comprises the CPU 11, the user interface 13, the device interface 14, the memory 15, a flash memory 16, and the controller 12 controlling these modules. The user interface 13 mediates input and output of information with input/output devices such as a mouse, a keyboard, and a display. The device interface 14 mediates input and output (transfer) of information with the information storage device 2.

The information storage device 2 comprises the MPU 21, the read/write controller 22, the storage module 23, the host interface 25, the RAM 26, and the controller 24 controlling these modules. The read/write controller 22 writes and reads data to and from the storage module 23. The host interface 25 mediates input and output of information with the host PC 1.

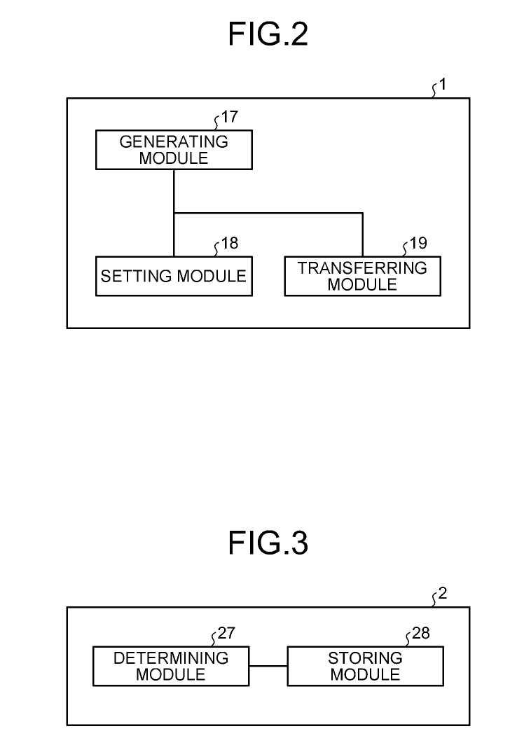

A functional configuration of the host PC 1 and the information storage device 2 will be described. FIG. 2 is a functional block diagram of the host PC 1 of the embodiment. FIG. 3 is a functional block diagram of the information storage device 2 of the embodiment.

As illustrated in FIG. 2, the host PC 1 of the embodiment comprises, as functional modules, a generating module 17, a setting module 18, and a transferring module 19. The generating module 17 generates a password. The setting module 18 sets the password generated by the generating module 17 to the information storage device 2 through the device interface 14. The transferring module 19 transfers the password generated by the generating module 17 to the information storage device 2 through the device interface 14 for authentication. A computer program may be stored in the flash memory 16 and executed by the CPU 11 to implement the function of the host PC 1 of the embodiment. The function of the host PC 1 of the embodiment may be implemented by a basic input/output system (BIOS).

As illustrated in FIG. 3, the information storage device 2 of the embodiment comprises, as functional modules, a determining module (determining module, releasing module) 27, and a storing module 28. The storing module 28 stores the password set by the setting module 18 in the storage module 23. The determining module 27 determines whether the password stored in the storage module 23 by the setting module 18 matches the password transferred by the transferring module 19. These modules may be implemented by the MPU 21 and stored as firmware in the storage module 23 or a nonvolatile memory (not illustrated in FIG. 1).

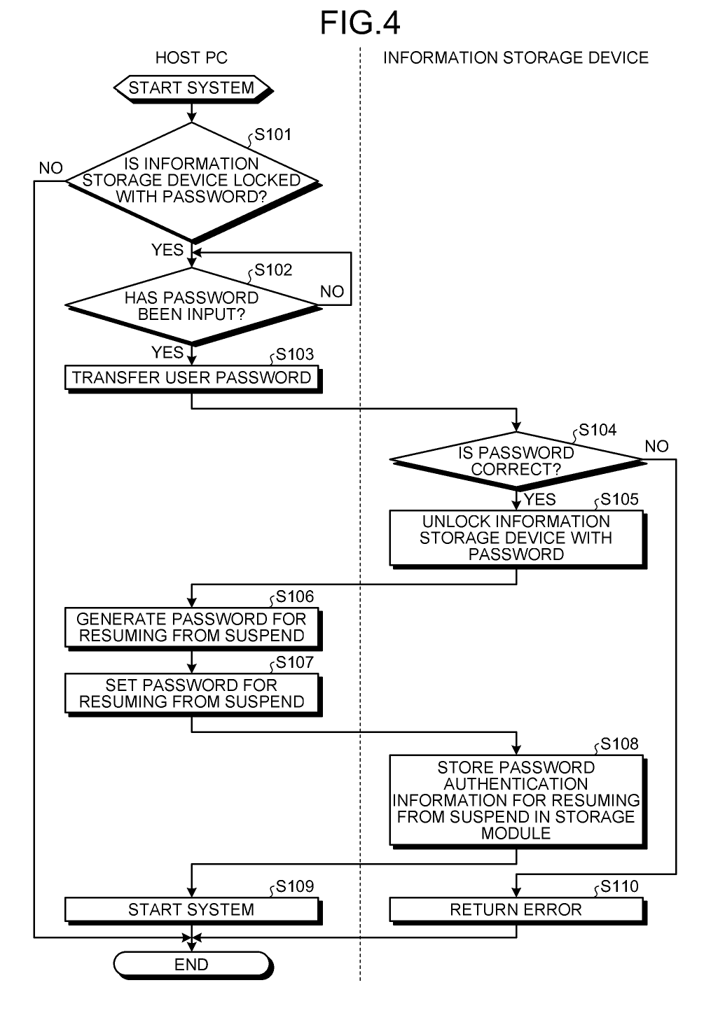

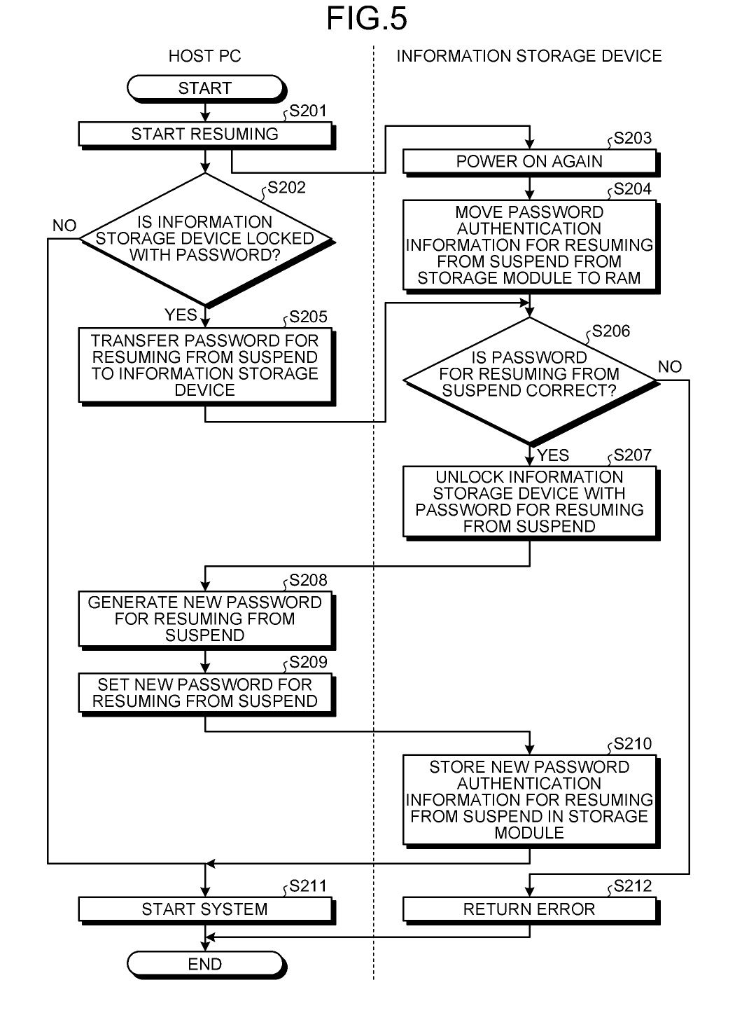

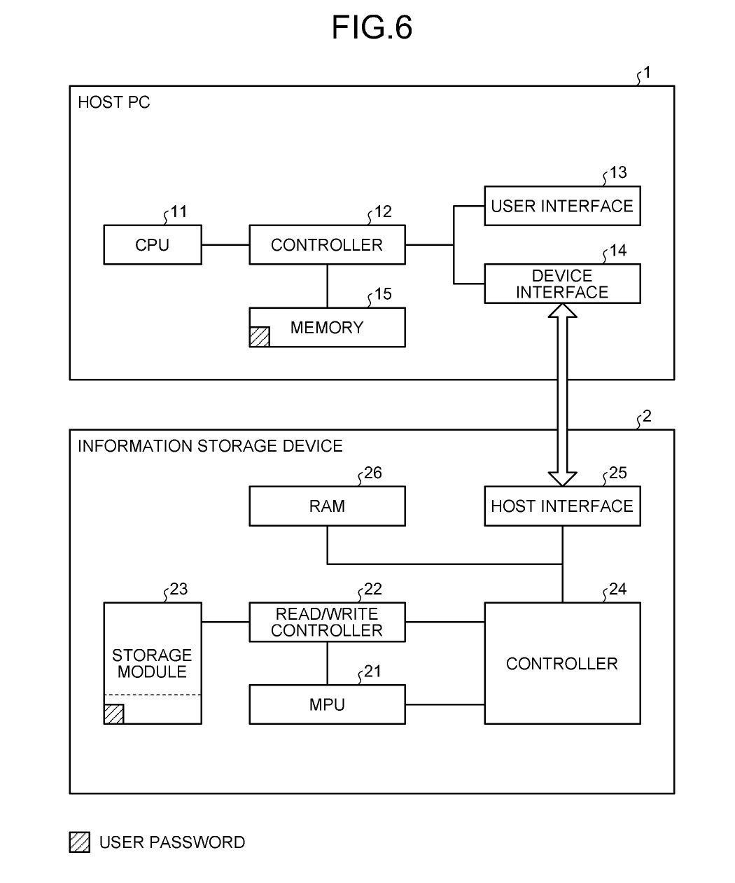

The operation of the computer system according to the embodiment will be described. FIG. 4 is a flowchart of a password setting process for resuming from suspend. It is assumed herein that a password (set authentication information) has been set to the information storage device 2 by the user, and that the information storage device 2 has already been locked with the password.

When the host PC 1 is turned on and the system starts, the transferring module 19 of the host PC 1 determines whether the information storage device 2 is locked with the password (in access restricted state) (S101).

If the information storage device 2 is locked with the password (YES at S101), the transferring module 19 determines whether the password has been input to the host PC 1 (S102).

If the password has been input to the host PC 1 (YES at S102), the transferring module 19 transfers the input password, i.e., user password (input authentication information), to the information storage device 2 (S103).

The determining module 27 of the information storage device 2 determines whether the transferred user password is correct, i.e., whether the transferred user password matches the preset password (S104).

If the password is correct (YES at S104), the determining module 27 unlocks the information storage device 2 with the password (S105).

Once the information storage device 2 is unlocked with the password, the generating module 17 of the host PC 1 generates a password for resuming from suspend (generated authentication information) based on random numbers (S106), and the setting module 18 sets the generated password for resuming from suspend to the information storage device 2 (S107). At this time, the setting module 18 stores the password for resuming from suspend set to the information storage device 2 in the memory 15.

Subsequently, the storing module 28 of the information storage device 2 stores the password for resuming from suspend set by the setting module 18 in the storage module 23 as authentication information (S108). The storage module 23 is an accessible management region even if the information storage device 2 is in the password lock state.

When the password for resuming from suspend is stored in the storage module 23, the host PC 1 starts the system (S109).

If the password is not correct (NO at S104), the determining module 27 returns an error notification to the host PC 1 (S110).

If the password has not been input to the host PC 1 (NO at S102), the transferring module 19 determines again whether the password has been input to the host PC 1 (S102).

If the information storage device 2 is not locked with the password (NO at S101), the process ends.

A password authentication process for resuming from suspend will be described. FIG. 5 is a flowchart of the password authentication process for resuming from suspend. It is assumed herein that the host PC 1 has already started the system and been suspended.

When the host PC 1 starts resuming from suspend (S201), the transferring module 19 determines whether the information storage device 2 is locked with a password (S202).

When the information storage device 2 is turned on again resulting from that the host PC 1 has resumed from suspend (S203), the determining module 27 loads the password for resuming from suspend stored as the authentication information from the storage module 23 into the RAM 26 (S204). At this time, the determining module 27 deletes the password for resuming from suspend that is stored in the storage module 23. Accordingly, when the information storage device 2 is turned off again, the password for resuming from suspend is invalid.

If the information storage device 2 is locked with the password (YES at S202), the transferring module 19 reads the password for resuming from suspend stored in the memory 15 or the management region of the storage module 23 at the time of setting to transfer the password to the information storage device 2 (S205).

Upon receipt of the password for resuming from suspend from the host PC 1, the determining module 27 of the information storage device 2 determines whether the password for resuming from suspend as the authentication information matches the transferred password for resuming from suspend, i.e., whether the transferred password for resuming from suspend is correct (S206).

If the password for resuming from suspend is correct (YES at S206), the determining module 27 unlocks the information storage device 2 with the password for resuming from suspend (S207). At this time, the determining module 27 deletes the password for resuming from suspend loaded into the RAM 26. By using the password for resuming from suspend as a one-time password, the security of the information storage device 2 can be enhanced. Even if the information storage device 2 is not unlocked with the password, when the information storage device 2 is shut down, the password for resuming from suspend is deleted because the information in the RAM 26 is volatile.

When the information storage device 2 is unlocked with the password, the generating module 17 of the host PC 1 deletes the password for resuming from suspend on the memory 15 and generates a password different from the transferred password for resuming from suspend based on random numbers (S208). Subsequently, the setting module 18 sets the generated password for resuming from suspend to the information storage device 2 (S209).

When the new password for resuming from suspend is set by the setting module 18, the storing module 28 of the information storage device 2 stores the new password for resuming from suspend in the storage module 23 as authentication information (S210), and the host PC 1 starts the system (S211).

If the password for resuming from suspend is not correct (NO at S206), the determining module 27 returns an error notification to the host PC 1 (S212).

If the information storage device 2 is not locked with the password (NO at S202), the host PC 1 starts the system (S211).

As described above, according to an embodiment of the invention, a password different from a user password set by the user is generated for every authentication. Consequently, when the information storage device 2 is unlocked resulting from that the host PC 1 has resumed from suspend, it is not necessary to store the user password in a place that is readily read by a third party (the memory 15 or the management region of the storage module 23). The user password is not stored in a place with security concerns, such as the memory 15 or the management region, which prevents the user password from being stolen, and thus, prevents data leakage.

More over, if the information storage device 2 is unlocked with the generated password, the host PC 1 and the information storage device 2 delete the password used for unlocking. This further enhances the security.

Furthermore, if the power of the information storage device 2 is interrupted due to a cause other than the transition of the host PC 1 to suspend mode, the power of the host PC 1 is also interrupted at this time. Accordingly, the PC 1 is not required to resume from the suspend mode, and therefore, the password being volatile is deleted.

Still further, the security at the time of resuming from a suspend mode can be enhanced.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a storing module configured to store generated authentication information generated by a host connected to the storage device and set as authentication information for releasing access restriction to a storage module in the storage module;
a determining module configured to determine, when the storage device is turned on upon the host resuming from suspend mode and receives generated authentication information from the host in a state where access to the storage module is restricted, whether the generated authentication information matches the generated authentication information stored by the storing module in the storage module; and
a releasing module configured to release, when the determining module determines that the generated authentication information received from the host matches the generated authentication information stored by the storing module in the storage module, access restriction to the storage module.

2. The storage device of claim 1, wherein, upon determining whether the generated authentication information received from the host matches the generated authentication information stored by the storing module in the storage module, the determining module is configured to read the generated authentication information from the storage module and deletes the generated authentication information from the storage module.

3. The storage device of claim 1, wherein the storing module is configured to store, when the releasing module releases the access restriction to the storage module based on the generated authentication information, generated authentication information different from the generated authentication information used for releasing the access restriction.

4. The storage device of claim 1, wherein
the determining module is configured to determine, when receiving from the host input authentication information input to the host in a state where access to the storage module is restricted after the storage device is turned on upon start-up of the host, whether the input authentication information matches set authentication information preset in the storage device,
the releasing module is configured to release, when the determining module determines that the input authentication information matches the set authentication information, access restriction to the storage module, and
the storing module is configured to store, when the releasing module releases the access restriction to the storage module based on the input authentication information, the generated authentication information in the storage module.

5. An information processor comprising:
a generating module configured to generate predetermined authentication information as generated authentication information;
a setting module configured to set the generated authentication information generated by the generating module to a storage device connected to the information processor as authentication information for releasing access restriction to a storage module of the storage device; and
a transferring module configured to transfer, when the storage device is turned on upon the information processor resuming from suspend mode and access to the storage module is restricted, the generated authentication information generated by the generating module to the storage device.

6. The information processor of claim 5, wherein
the generating module is configured to generate, when the access restriction to the storage module of the storage device is released based on the generated authentication information transferred by the transferring module, authentication information different from the generated authentication information used for releasing the access restriction as generated authentication information, and
the transferring module is configured to transfer the generated authentication information generated by the generating module and different from the generated authentication information used for releasing the access restriction to the storage device.

7. The information processor of claim 5, wherein
the transferring module is configured to transfer to the storage device, when the storage device is turned on upon start-up of the information processor and access to the storage module is restricted, input authentication information input to the information processor for releasing the access restriction to the storage module of the storage device based on set authentication information preset to the storage device, and
the generating module is configured to generate the predetermined authentication information as generated authentication information when the access restriction to the storage module of the storage device is released based on the input authentication information transferred by the transferring module.

8. An information processing system comprising:
an information processor; and
a storage device configured to be connected to the information processor, wherein
the information processor comprises
a generating module configured to generate predetermined authentication information as generated authentication information;
a setting module configured to set the generated authentication information generated by the generating module to the storage device as authentication information for releasing access restriction to a storage module of the storage device; and
a transferring module configured to transfer, when the storage device is turned on upon the information processor resuming from suspend mode and access to the storage module is restricted, the generated authentication information generated by the generating module to the storage device, and
the storage device comprises
a storing module configured to store the generated authentication information set by the setting module in the storage module;
a determining module configured to determine, upon receipt of the generated authentication information from the transferring module of the information processor, whether the generated authentication information matches the generated authentication information stored by the storing module in the storage module; and
a releasing module configured to release the access restriction to the storage module when the determining module determines that the generated authentication information received from the transferring module of the information processor matches the generated authentication information stored by the storing module in the storage module.

9. The information processing system of claim 8, wherein, upon determining whether the generated authentication information received from the transferring module matches the generated authentication information stored by the storing module in the storage module, the determining module is configured to read the generated authentication information from the storage module and deletes the generated authentication information from the storage module.

10. The information processing system of claim 8, wherein
when the releasing module releases the access restriction to the storage module based on the generated authentication information transferred by the transferring module,
the generating module generates authentication information different from the generated authentication information used for releasing the access restriction as generated authentication information,
the transferring module transfers the generated authentication information generated by the generating module that is different from the generated authentication information used for releasing the access restriction to the storage device, and
the storing module stores the generated authentication information received from the transferring module in the storage module.

11. The information processing system of claim 8, wherein
when the storage device is turned on upon start-up of the information processor and access to the storage module is restricted,
the transferring module transfers input authentication information input to the information processor to the storage device,
the determining module determines whether the input authentication information transferred by the transferring module matches set authentication information preset to the storage device,
the releasing module releases, when the determining module determines the input authentication information matches the set authentication information, the access restriction to the storage module, and
the generating module generates the predetermined authentication information as generated authentication information when the releasing module releases the access restriction to the storage module of the storage device based on the input authentication information.
